(19) United States
(12) Patent Application Publication
(10) Pub. No.: US 2019/0207376 A1
(43) Pub. Date: Jul. 4, 2019

(54) SYSTEM AND METHOD FOR SWITCHING LINE SHORT-CIRCUIT FAULT SECTION IN INVERTER-BASED STAND-ALONE MICROGRID

(71) Applicant: KOREA ELECTRIC POWER CORPORATION, Naju-si (KR)

(72) Inventors: Jong-Nam WEON, Daejeon (KR); Woo-Kyu CHAE, Daejeon (KR); Hak-Ju LEE, Daejeon (KR); Jung-Sung PARK, Daejeon (KR); Jun-Bo SIM, Daejeon (KR)

(21) Appl. No.: 16/327,297

(22) PCT Filed: Nov. 14, 2016
(86) PCT No.: PCT/KR2016/013069

§ 371 Date: Feb. 21, 2019

(30) Foreign Application Priority Data
Sep. 20, 2016 (KR) 10-2016-0120113

(51) Int. Cl. H02H 3/05; H02H 3/08; H02H 7/26; H02J 3/38

(52) U.S. Cl. CPC H02H 3/05; H02J 3/38; H02H 7/26; H02H 3/081

(57) ABSTRACT

The present invention provides a system and a method for switching a line short-circuit fault section in an inverter-based stand-alone microgrid, the system comprising: multiple intelligent switchgears disposed on a line in a stand-alone microgrid so as to control opening or closing of the line; a battery inverter having a built-in current limiter so as to limit a current output therefrom; and an operating system for receiving short-circuit fault information of the line from the multiple intelligent switchgears, determining a fault section, and controlling the battery inverter to limit the output current. The present invention can quickly and accurately switch a line short-circuit fault section occurring in a stand-alone microgrid which does not include separate cutoff equipment such as a recloser.

### TECHNICAL FIELD

The present invention relates to a system and a method of switching a short-circuit fault section when a line short-circuit fault occurs in an inverter-based stand-alone microgrid.

### BACKGROUND ART

The electric power system of an island area cannot receive power from the large scale system of a mainland area, so electric power in the island area is produced and supplied through an internal combustion generator.

When the internal combustion generator is used in this way, the cost of operating the power plant is much higher due to the fuel cost, and the cost of generating electric power is much higher compared with the mainland system.

In addition, there are disadvantages that an environmental pollution problem such as CO₂ emission is involved, and the electric power quality is remarkably lower compared with the mainland system.

In order to solve these problems, stand-alone microgrids have been spreading widely as independent systems in many island areas inside and outside the country.

Since the stand-alone microgrid uses new renewable energy, an energy storage device, etc., and fuel consumption can be reduced, thereby reducing environmental pollution and reducing operating costs.

In particular, the stand-alone microgrid is a small scale inverter-based power system, because an inverter in the energy storage device becomes the main power source to repeat charging and discharging of a battery and maintain voltage and frequency.

The stand-alone microgrid can solve many problems of internal combustion power plants in the related art, but the method and procedure for handling the fault occurring in a line has no difference between before and after the application of the stand-alone microgrid.

In the case of a general independent system in an island area, the distribution line is made of resin, and only a manual switchgear is disposed on the line, but separate cutoff equipment such as a recloser is not provided.

Therefore, when a fault occurs, a high voltage circuit breaker in the power plant has to be opened, and a power failure occurs in the entire line where the fault occurs.

Since the independent system in the island area has a non-grounded line different from a mainland system, the fault current is very small when the ground fault occurs, whereby it is possible to switch the fault section using the switchgear disposed on the line.

However, when a short-circuit failure occurs, the fault current is very large and to thus cannot be blocked by the switchgear, and the high-voltage circuit breaker has to be opened as shown in FIG. 1, whereby the entire line must be shut down.

Therefore, when a short-circuit fault occurs, it is necessary to open the circuit breaker and then find and repair the fault point, whereby the operator has to confirm the fault point directly with the naked eye. Since there is no information about the fault section, it takes much time to confirm the entire line, whereby the power failure time also becomes longer.

When the fault point is found, the process is performed so that the switchgear is opened to switch the fault section, to recover the normal section, and then to finally close the opened switchgear, thereby recovering the fault section.

Of course, since a distribution intelligence system (DAS) is applied to many island areas, the intelligent switchgear capable of communicating is used to discriminate the fault section and transfer information on the fault section to the operator, whereby the fault recovery time is shortened.

However, when a short-circuit fault occurs even when an intelligent switchgear is provided, the fault section cannot be switched by the intelligent switchgear and the circuit breaker has to be opened, whereby the entire fault line must be shut down.

This procedure is applied even when an inverter-based stand-alone microgrid is constructed. Therefore, when the short-circuit fault occurs in the line, the entire line must be shut down, and the time required to switch the fault section is very long.

Considering this fact, when a stand-alone microgrid is applied to an independent system in an island area, it is necessary to provide a method of quickly switching the fault section with the entire line not being shut down even when a short circuit fault occurs in the line.

[symbol]

Of technologies in the related art, methods of switching the failure section, such as Korean Patent Nos. 10-1028745, 10-1294698, 10-1514999, etc., are for general power distribution systems in a mainland area.

The above mentioned technologies in the related art can be applied only when the type of fault is a ground fault. In the case of a short-circuit fault, a method of switching a fault section is performed by using a recloser, a fault section switching switchgear, and the like provided in the middle of the line.

However, in the case of the independent system in the island areas, it is generally difficult to apply the corresponding technologies because these protection devices are not provided.

There are a number of methods of switching the fault section in a non-grounded system in the island areas on the basis of internal combustion power generation such as Korean Patent Nos. 10-0675739 and 10-0740151. However, these methods are applicable only to a case where a type of the fault is a ground fault, and method for short-circuit fault does not exist.

As a result, when a short-circuit fault occurs in the island area system, the entire line will have to be shut down, and the time taken to switch and recover the fault section will be very long.

[symbol]

The matters described in the background art are intended to aid understanding of the background of the invention and may include matters not previously known to those skilled in the art.

### DISCLOSURE

### Technical Problem

The present invention has been made to solve the above-mentioned problems, and it is an object of the present invention to provide a method and system for quickly and accurately switching a line short-circuit fault section which occurs in a stand-alone microgrid which does not include separate cutoff equipment such as a recloser.

### Technical Solution

A system for switching a line short-circuit fault section in an inverter-based stand-alone microgrid according to an aspect of the present invention includes multiple intelligent switchgears disposed on a line in the stand-alone microgrid so as to control opening or closing of the line; a battery inverter having a current limiter built therein so as to limit an output current; and an operating system receiving information on a short-circuit fault of the line from the multiple intelligent switchgears, determining a fault section, and controlling the battery inverter to limit the output current.

The operating system may determine the fault section on the basis of information to received from the intelligent switchgears and perform control to open an intelligent switchgear disposed in front of the determined fault section.

In addition, the operating system may check whether or not the battery inverter limits the output current and perform control to open the intelligent switchgear.

In addition, the operating system may check whether a magnitude of a short-circuit fault current limited by the battery inverter is smaller than a magnitude of a minimum current that is capable of opening the intelligent switchgear and perform control to open the intelligent switchgear.

The operating system may check whether a magnitude of a short-circuit fault current limited by the battery inverter is smaller than a magnitude of a minimum current that is capable of opening the intelligent switchgear and perform control to open a circuit breaker disposed on the line when the current is not limited by the battery inverter.

In addition, when the short-circuit fault occurs in a section between a circuit breaker disposed on the line and a first intelligent switchgear from the circuit breaker, the operating system may perform control to open the circuit breaker.

In addition, when the intelligent switchgear is opened and the failure section is switched, the operating system may perform control to terminate the current limiting of the battery inverter.

Herein, the operating system may check whether or not the fault section is switched and perform control to open the circuit breaker disposed on the line when the switching of the fault section is impossible.

In addition, the operating system may check whether or not normal current flows in an intelligent switchgear disposed in front of the opened intelligent switchgear to check whether or not the fault section is switched.

[symbol]

A system for switching a line short-circuit fault section in an inverter-based stand-alone microgrid according to another aspect of the present invention includes multiple intelligent switchgears disposed on a line in the stand-alone microgrid so as to control opening or closing of the line; an output limiting means limiting an output current on the line; and an operating system controlling the output limiting means to limit the output current, when a short-circuit fault is determined by receiving information on the short-circuit fault of the line from the multiple intelligent switchgears.

The operating system may open an intelligent switchgear disposed in front of a point of the short-circuit fault when the output current is limited by the output limiting means.

In addition, the output limiting means may limit the output current to be less than a magnitude of a minimum current that is capable of opening the intelligent switchgear.

[symbol]

A method of switching a line short-circuit fault section in an inverter-based stand-alone microgrid according to an aspect of the present invention includes limiting an output current in a battery inverter having a current limiter built therein to limit the output current, when a short-circuit fault occurs on a line of the stand-alone microgrid; and opening an intelligent switchgear disposed in front of a point of the short-circuit fault when the output current is limited in the limiting of the output current.

In addition, the method may further includes measuring, by the intelligent switchgear, a fault current to transmit fault information to an operating system; determining whether or not the fault information received by the operating system is on the short-circuit fault; and limiting the output current in the battery inverter when the short-circuit fault is determined.

The determining of whether or not the fault information may be on the short-circuit fault determines that there is the short-circuit fault when a magnitude of the fault current received according to the fault information is larger than an operating current of an over current relay.

In addition, the method may further include determining whether a fault section due to the short-circuit fault is a section between a circuit breaker on the line and a first intelligent switchgear; and opening the circuit breaker on the line when the fault section is the section between the circuit breaker on the line and the first intelligent switchgear.

The limiting of the output current may limit the output current to be less than a magnitude of a minimum current that is capable of opening the intelligent switchgear.

In addition, the method may further include checking whether the output current is limited to less than the magnitude of the minimum current that is capable of opening the intelligent switchgear in the limiting of the output current, wherein the opening of the intelligent switchgear is performed by checking whether the output current is limited.

The method may further include opening a circuit breaker disposed on the line when the output current is not limited, as a result of checking the limiting of the output current.

The method may further include terminating the limiting of the output current, when the intelligent switchgear is opened to switch the fault section in the opening of the intelligent switchgear.

The method may further include opening a circuit breaker disposed on the line when the switching of the fault section is impossible.

In addition, the method may further include checking whether or not normal current flows in an intelligent switchgear disposed in front of the opened intelligent switch, thereby checking whether or not the fault section is switched by checking whether or not the normal current flows in the intelligent switchgear disposed in front of the opened intelligent switchgear.

### Advantageous Effects

According to a method and system for switching a line short-circuit fault section occurring in an inverter-based stand-alone microgrid of the present invention, the following effects are provided.

First, in the inverter-based stand-alone micorgrid, it is possible to quickly detect and switch a fault section when a line short-circuit fault has occurred, so that the fault section can be switched without a power failure and the power can be normally supplied to the normal section.

Second, in the inverter-based stand-alone micorgrid, it is not necessary to separately provide a circuit breaker on the line in order to interrupt the fault current because the fault section can be switched only by the intelligent switchgear.

Third, it is possible to strengthen market competitiveness by performing integration with stand-alone microgrid technology.

### DESCRIPTION OF DRAWINGS

FIG. 1 is a view conceptually illustrating a situation due to a line fault in a stand-alone microgrid in the related art.

FIG. 2 is a view illustrating switching of a fault section by an intelligent switchgear.

FIG. 3 is a view illustrating an example of a fault section according to a short-circuit fault.

FIG. 4 is a view illustrating a system for switching a line short-circuit fault section in an inverter-based stand-alone microgrid according to the present invention.

FIGS. 5A and 5B are a view illustrating an output current limit performed by an inverter current limiter.

FIG. 6 is a flow diagram illustrating a method of switching a line short-circuit fault section in an inverter-based stand-alone microgrid according to the present invention.

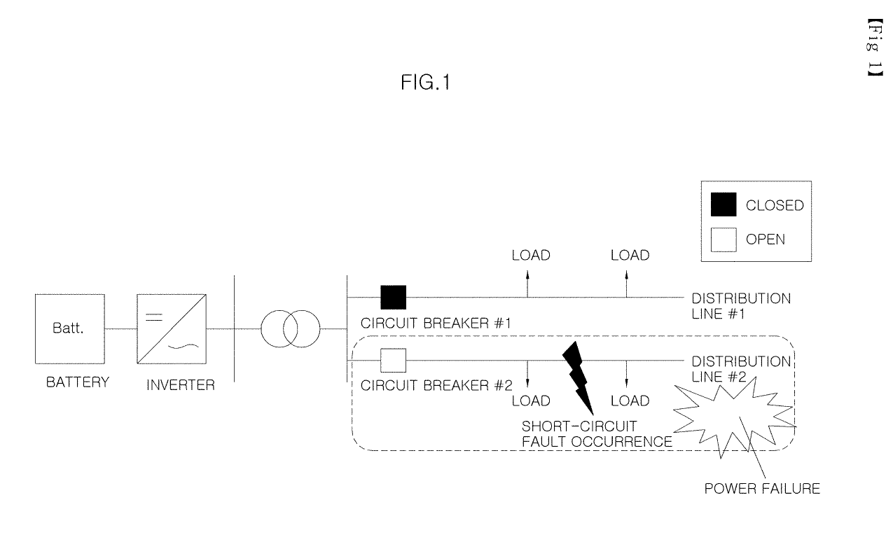

### BEST MODE

In order to fully understand operational advantages of the present invention and objects achieved by the practice of the present invention, reference should be made to the accompanying drawings which illustrate preferred embodiments of the present invention and contents described in the accompanying drawings.

In describing the preferred embodiments of the present invention, a description of known or repeated descriptions that may unnecessarily obscure the gist of the present invention will be reduced or omitted.

As intelligent distribution systems have been distributed to island areas, intelligent switchgears have been built in many island areas. However, it is possible only to provide and receive fault information through communication, but impossible to switch the fault section at the time of the short-circuit fault.

However, even when a short-circuit fault occurs, when the magnitude of the fixed current becomes small enough that the intelligent switchgear may open, it is possible to switch the fault section using only switchgear without a need to open the circuit breaker of the line.

For this purpose, a device for reducing the magnitude of the fault current is required, which may be realized by a battery inverter which is the main power source of the stand-alone microgrid.

That is, it is possible to instantaneously limit the magnitude of the fault current using a current limiter built in the inverter when the short-circuit fault occurs.

In other words, since the battery inverter limits the magnitude of the short-circuit to fault current, and the intelligent switchgear is opened to switch only the fault section without a power failure of the entire line, it is possible to supply the power to the normal sections.

In consideration of this, a method of switching a fault section without a power failure when the line short-circuit fault occurs in the inverter-based stand-alone microgrid according to the present invention is configured of detecting the short-circuit fault by an operating system, switching the fault section via the intelligent switchgear, and limiting the magnitude of the fault current by using the battery inverter.

When the short-circuit fault occurs in the line, the fault current flows, the fault information is transferred to a stand-alone microgrid operating system (hereinafter referred to as “operating system”) by the intelligent switchgear.

The operating system determines whether the short-circuit fault occurs through the received fault information. In addition, fault sections are determined by the operating system according to the fault information received from each intelligent switchgear.

Next, the operating system instructs the battery inverter to perform the output current limiting function, so that the magnitude of the short-circuit current may be made small enough that the switchgear may open through the output current limiting function of the inverter.

Generally, when the short-circuit fault occurs, a short-circuit current of a few to several tens of times of rated current flows, whereby a switchgear without a fault current shut-off function cannot interrupt the short-circuit current. However, when the magnitude of the current becomes smaller through the output current limiting function, it is possible to switch the fault section because the switchgear may be opened.

When the magnitude of the short-circuit current is limited to be equal or less than a predetermined value (the magnitude of the current that the switchgear may open), the operating system instructs to open the intelligent switchgear disposed just before the fault section.

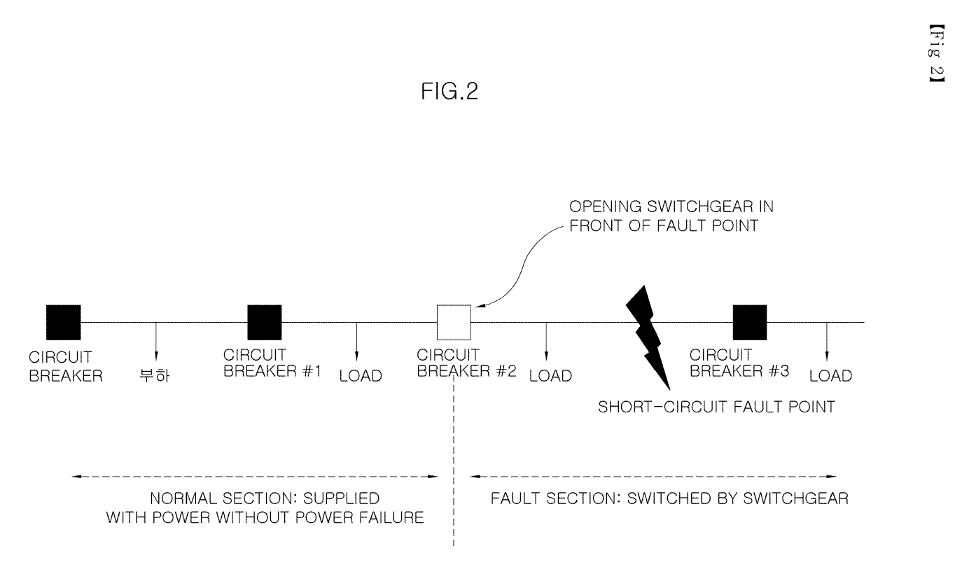

In this case, as shown in FIG. 2, only the fault section is switched and the power may be normally supplied to the normal sections in front of the opened intelligent switchgear without a power failure.

However, when the point where the fault occurs is immediately behind the circuit breaker (between the high voltage circuit breaker and the first circuit breaker on the resin line), the circuit breaker must be opened because it is not impossible to switch the fault section using the breaker.

Multiple intelligent switchgears capable of detecting the short-circuit fault are disposed on the line, and fault sections are classified according to the point where the fault occurs on the basis of the intelligent switches.

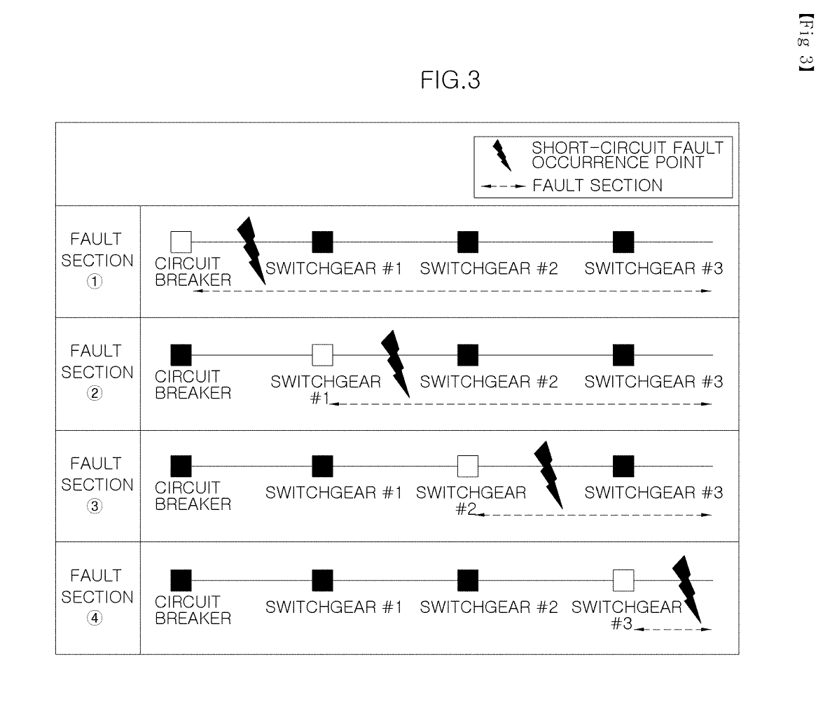

FIG. 3 illustrates an example having three switchgears on the line, in which the fault sections are shown according to the point where the short-circuit fault occurs on the basis of the three switchgears. In the case of the example having three switchgears, it will be appreciated that it is possible to be classified into fault sections of four cases.

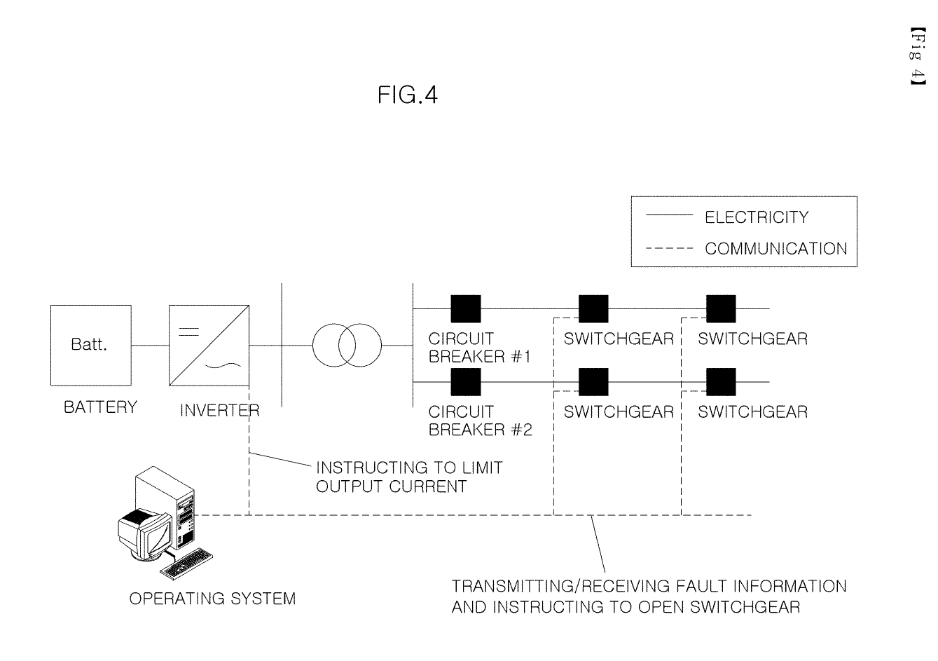

FIG. 4 illustrates a system for switching a line short-circuit fault section in an inverter-based stand-alone microgrid according to an embodiment of the present invention.

Referring to FIG. 4, a system for switching a line short-circuit fault section in an inverter-based stand-alone microgrid according to an embodiment of the present invention includes multiple intelligent switchgears, a battery inverter, and an operating system.

The intelligent switchgear includes a switchgear and a feeder remote terminal unit (FRTU).

The switchgear has a PT and a CT built therein so that the failure information may be acquired by measuring the voltage, the current, and the like, and the switchgear may be opened and closed depending on the situation.

The terminal unit is connected to the operating system via communication to transmit the fault information, receive the instruction, and control the opening and closing of the switchgears.

In the present invention, multiple intelligent switchgears are disposed on the line, and the fault sections may be classified on the basis of the intelligent switchgears.

When the short-circuit fault occurs, the fault is detected by the switchgear, and the terminal unit is connected to the operating system via communication to transfer the corresponding information thereto.

When the short circuit current is limited by the operating system and the battery inverter, the specific switchgear is opened according to the fault section so as to switch the fault section.

The battery inverter serves to convert the DC voltage of the battery into the AC voltage of the system using the power electronic-based switching element.

In the stand-alone microgrid, the battery inverter becomes the main power source and the voltage and frequency of the whole system is maintained.

The battery inverter has a current limiter built therein, thereby making it possible to limit the output current.

According to the present invention, the operating system instructs to operate the output current limiting function according to the occurrence of the fault, the magnitude of the short-circuit current is limited to the magnitude that the switchgear may be opened and closed

The operating system implements and performs the entire logic of the present invention.

The operating system is connected to the terminal unit and the battery inverter of the multiple intelligent switchgears via communication and transmits/receives failure information and instructions.

The operating system determines the fault section according to the detection result of the short-circuit fault received from the terminal unit of the intelligent switchgear and instructs the battery inverter to perform the output current limiting function.

Accordingly, when the short-circuit current is limited, the terminal unit is instructed to open the switchgear according to the fault section.

[symbol]

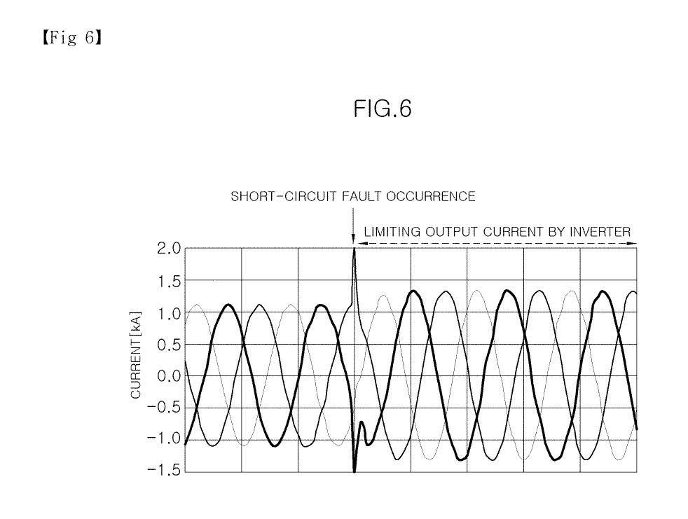

FIG. 6 shows a flow diagram illustrating a method of switching a line short-circuit fault section in an inverter-based stand-alone microgrid according to an embodiment of the present invention.

Hereinafter, a method of switching a line short-circuit fault section in an inverter-based stand-alone microgrid according to an embodiment will be sequentially described with reference to FIG. 6.

### Short-Circuit Fault Detection and Fault Section Determination—S10, S20

When the short-circuit fault occurs in the line, a fault current flows. The fault current is measured by the intelligent switchgear, and the terminal unit determines that the fault has occurred through the fault current.

Next, the corresponding fault information (three-phase voltage, current) is to transmitted to the operating system in order to determine a type of the fault.

The operating system determines whether or not the short-circuit fault has occurred through the received information. When no voltage is present and the magnitude of the detected fault current is greater than the operating current of an over current relay (OCR), it is determined that the fault is a short-circuit fault.

When the operating system checks the occurrence of the short-circuit fault, the operating system receives information from multiple intelligent switchgears disposed on the line to determine the fault section. The fault section is determined by checking no-voltage and a direction of the fault current measured by the switchgear.

[symbol]

### Checking Whether There is Fault in First Fault Section—S30

When the fault section is the first section immediately after the breaker (between the high-voltage breaker and the first breaker on the resin line), it is impossible to switch the fault section because there is no switchgear in front of the fault section.

In this case, the breaker must be opened, and the entire line becomes a fault section, whereby a power failure occurs.

[symbol]

### Limiting Short-Circuit Fault Current by Battery Inverter—S40

When the fault occurrence point is not the first section, the operating system instructs the battery inverter to perform the output current limiting function.

Upon receiving the instruction, the inverter performs the current limiting function using the built-in current limiter to limit the magnitude of the short-circuit fault current to a current magnitude enough that the switchgear may open/close.

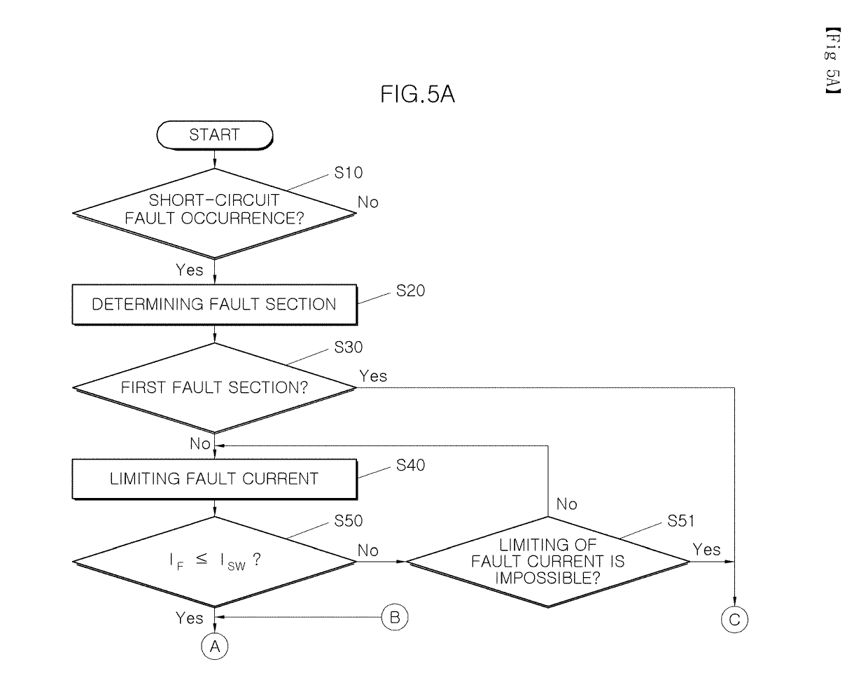

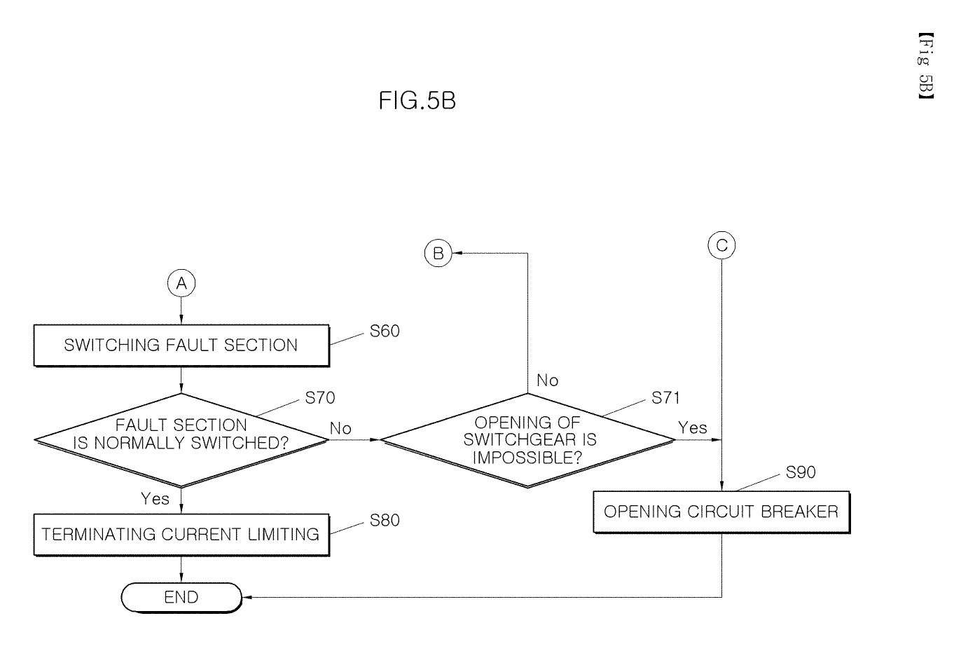

As shown in FIGS. 5A and 5B, the magnitude of current instantaneously sharply increases due to the occurrence of the short-circuit fault, but the current is immediately limited by the battery inverter.

As shown, the magnitude of the current is limited to approximately the same magnitude as the load current before the short-circuit fault.

[symbol]

### Determining Whether the Intelligent Switchgear May Be Opened—S50

The operating system determines whether the magnitude of the fault current becomes small enough that the switchgear may open or close through the output current limiting function of the battery inverter.

I_{F}≤I_{SW} [Equation 1]

Herein, I_{F}: magnitude of short-circuit fault current limited by the inverter [A]

I_{SW}: magnitude of minimum current that the switchgear may open [A]

When it is impossible to limit the short-circuit current to less than I_{SW} due to a fault situation, a malfunction of the current limiting function, or the like (S51), the high-voltage circuit breaker on the line is opened to prevent the fault from being propagated (S90).

[symbol]

### Switching Fault Section Via Operation of Intelligent Switchgear—S60

When the condition of S50 is satisfied, the operating system instructs to open the intelligent switchgear provided immediately before the fault section, and accordingly the intelligent switchgear is opened so that the fault section is switched and the normal section is normally supplied with power without a power failure. The opened intelligent switchgear transfers the corresponding information to the operating system.

### Checking Whether Fault Section is Normally Switched and Terminating Current Limiting Function—S70, S80

The operating system receives information on the opened switchgear from the terminal unit of the opened switchgear and checks whether or not the fault is detected in an intelligent switchgear (located in the normal section) disposed in front of the opened intelligent switchgear so as to check whether the fault section is normally switched.

When the switchgear is normally opened to switch the fault section, the operating system instructs the battery inverter to terminate the current limiting function.

When the switchgear cannot be opened due to a malfunction, a communication error, or the like so that the fault section is not normally switched (S71), the high voltage circuit breaker on the line is opened to prevent the fault from being propagated (S90).

[symbol]

As described above, the system and method of switching a line short-circuit fault section in the inverter-based stand-alone microgrid according to the present invention enables the intelligent switchgear to be opened by controlling a battery inverter when a short-circuit fault occurs in a stand-alone microgrid which does not include separate cutoff equipment such as a recloser, whereby it is possible to quickly and accurately identify the fault section and switch the fault line, and to quickly cope with the short-circuit fault and prevent the normal section from being shutdown, thereby making it possible to maintain the power supply more stably.

While the present invention has been described with reference to exemplary embodiments, it will be obvious to those of ordinary skill that the invention is not limited to the disclosed exemplary embodiments, but, on the contrary, is intended to cover various modifications and alternative arrangements included within the spirit and scope of the invention. Accordingly, it is intended that the present invention cover the modifications and variations of this invention provided they come within the scope of the appended claims and their equivalents.

[symbol]

### DESCRIPTION OF THE REFERENCE NUMERALS

S10: detecting short-circuit fault

S20: determining fault section

S30: checking whether there is fault in first fault section?

S40: limiting fault current by battery inverter

S50: determining whether it is possible to open intelligent switchgear

S51: limiting of fault current is impossible?

S60: switching fault section through operation of intelligent switchgear

S70: checking whether fault section is normally switched

S71: checking whether opening of switchgear is impossible

S80: terminating current limiting

S90: opening high voltage circuit breaker

1. A system for switching a line short-circuit fault section in an inverter-based stand-alone microgrid, the system comprising:
multiple intelligent switchgears disposed on a line in the stand-alone microgrid so as to control opening or closing of the line;
a battery inverter having a current limiter built therein so as to limit an output current; and
an operating system receiving information on a short-circuit fault of the line from the multiple intelligent switchgears, determining a fault section, and controlling the battery inverter to limit the output current.

2. The system of claim 1, wherein the operating system determines the fault section on the basis of information received from the intelligent switchgears and performs control to open an intelligent switchgear disposed in front of the determined fault section.

3. The system of claim 2, wherein the operating system checks whether or not the battery inverter limits the output current and performs control to open the intelligent switchgear.

4. The system of claim 3, wherein the operating system checks whether a magnitude of a short-circuit fault current limited by the battery inverter is smaller than a magnitude of a minimum current that is capable of opening the intelligent switchgear and performs control to open the intelligent switchgear.

5. The system of claim 3, wherein the operating system checks whether a magnitude of a short-circuit fault current limited by the battery inverter is smaller than a magnitude of a minimum current that is capable of opening the intelligent switchgear and performs control to open a circuit breaker disposed on the line when the current is not limited by the battery inverter.

6. The system of claim 4, wherein when the short-circuit fault occurs in a section between a circuit breaker disposed on the line and a first intelligent switchgear from the circuit breaker, the operating system performs control to open the circuit breaker.

7. The system of claim 4, wherein when the intelligent switchgear is opened and the failure section is switched, the operating system performs control to terminate the current limiting of the battery inverter.

8. The system of claim 7, wherein the operating system checks whether or not the fault section is switched and performs control to open the circuit breaker disposed on the to line when the switching of the fault section is impossible.

9. The system of claim 8, wherein the operating system checks whether or not normal current flows in an intelligent switchgear disposed in front of the opened intelligent switchgear to check whether or not the fault section is switched.

10. A system for switching a line short-circuit fault section in an inverter-based stand-alone microgrid, the system comprising:
multiple intelligent switchgears disposed on a line in the stand-alone microgrid so as to control opening or closing of the line;
an output limiting means limiting an output current on the line; and
an operating system controlling the output limiting means to limit the output current, when a short-circuit fault is determined by receiving information on the short-circuit fault of the line from the multiple intelligent switchgears.

11. The system of claim 10, wherein the operating system opens an intelligent switchgear disposed in front of a point of the short-circuit fault when the output current is limited by the output limiting means.

12. The system of claim 11, wherein the output limiting means limits the output current to be less than a magnitude of a minimum current that is capable of opening the intelligent switchgear.

13. A method of switching a line short-circuit fault section in an inverter-based stand-alone microgrid, the method comprising:
limiting an output current in a battery inverter having a current limiter built therein to limit the output current, when a short-circuit fault occurs on a line of the stand-alone microgrid; and
opening an intelligent switchgear disposed in front of a point of the short-circuit fault when the output current is limited in the limiting of the output current.

14. The method of claim 13, further comprising:
measuring, by the intelligent switchgear, a fault current to transmit fault information to an operating system;
determining whether or not the fault information received by the operating system is on the short-circuit fault; and
limiting the output current in the battery inverter when the short-circuit fault is determined.

15. The method of claim 14, wherein the determining of whether or not the fault information is on the short-circuit fault determines that there is the short-circuit fault when a magnitude of the fault current received according to the fault information is larger than an operating current of an over current relay.

16. The method of claim 13, further comprising:
determining whether a fault section due to the short-circuit fault is a section between a circuit breaker on the line and a first intelligent switchgear; and
opening the circuit breaker on the line when the fault section is the section between the circuit breaker on the line and the first intelligent switchgear.

17. The method of claim 13, wherein the limiting of the output current limits the output current to be less than a magnitude of a minimum current that is capable of opening the intelligent switchgear.

18. The method of claim 17, further comprising:
checking whether the output current is limited to less than the magnitude of the minimum current that is capable of opening the intelligent switchgear in the limiting of the output current,
wherein the opening of the intelligent switchgear is performed by checking whether the output current is limited.

19. The method of claim 18, further comprising:
opening a circuit breaker disposed on the line when the output current is not limited, as a result of checking the limiting of the output current.

20. The method of claim 18, further comprising:
terminating the limiting of the output current, when the intelligent switchgear is opened to switch the fault section in the opening of the intelligent switchgear.

21. The method of claim 20, further comprising:
opening a circuit breaker disposed on the line when the switching of the fault section is impossible.

22. The method of claim 21, further comprising
checking whether or not normal current flows in an intelligent switchgear disposed in front of the opened intelligent switch,
thereby checking whether or not the fault section is switched by checking whether or not the normal current flows in the intelligent switchgear disposed in front of the opened intelligent switchgear.
